(19) United States
(12) Patent Application Publication
(10) Pub. No.: US 2026/0262113 A1
(43) Pub. Date: Sep. 3, 2026

(54) METHOD AND APPARATUS FOR ENABLING RELAYING FOR A REMOTE UE USING AN IDEAL BACKHAUL LINK

(71) Applicant: Telefonaktiebolaget LM Ericsson (PUBL), Stockholm (SE)

(72) Inventors: Min WANG, Luleå (SE); Mattias Bergström, Singapore (SG); Jan CHRISTOFFERSSON, Luleå (SE); Nithin SRINIVASAN, Köln (SE); Tuomas TIRRONEN, Helsinki (FI); Zhang ZHANG, Beijing (CN)

(21) Appl. No.: 18/875,247

(22) PCT Filed: Jun. 26, 2023
(86) PCT No.: PCT/CN2023/102340

§ 371 Date: Dec. 16, 2024

Related U.S. Application Data
(60) Provisional application No. 63/356,267, filed on Jun. 28, 2022.

(51) Int. Cl. H04W 76/14; H04W 68/02; H04W 76/15; H04W 76/19; H04W 92/18

(52) U.S. Cl. CPC H04W 76/14; H04W 68/02; H04W 76/15; H04W 76/19; H04W 92/18

(57) ABSTRACT

Various embodiments of the present disclosure provide a method for enabling relaying. The method which may be performed by a first user equipment (UE) comprises: establishing a direct communication path to a network node and establishing an indirect communication path to the network node through a second UE. The indirect communication path comprises an ideal backhaul link between the first UE and the second UE. In accordance with an exemplary embodiment, the method further comprises: communicating with the network node over the direct communication path and the indirect communication path. In an embodiment, when a radio bearer (RB) of the first UE is mapped to the indirect communication path which comprises a first hop between the first UE and the second UE and a second hop between the second UE and the network node, a packet data convergence protocol (PDCP) entity of the RB is directly mapped to a radio link control (RLC) entity of the second hop in the indirect communication path.

### FIELD OF THE INVENTION

The present disclosure relates generally to communications, and more particularly to communication methods and related devices and nodes supporting wireless communications.

### BACKGROUND

New Radio (NR) sidelink (SL) communication was specified by the 3rd Generation Partnership Project (3GPP) in Rel-16. The NR SL is an evolution of the LTE sidelink, in particular of the features introduced in Rel-14 and Rel-15 for V2X communication. Some of the most relevant features of the NR sidelink are the following:
Support for unicast and groupcast transmissions, in addition to broadcast transmissions, which were already supported in LTE.
Support for HARQ feedback over the SL for unicast and groupcast. This feedback is conveyed by the receiver user equipment (UE) to the transmitted UE using the physical sidelink feedback channel (PSFCH). This functionality is new in NR compared to LTE.
To alleviate resource collisions among different sidelink transmissions launched by different UEs, it enhances channel sensing and resource selection procedures, which also lead to a new design of physical channels carrying the sidelink control information (SCI). The new design of the SCI simplifies coexistence between releases by grouping together all the information related to resource allocation (which is critical for coexistence) in a single channel with a robust, predefined format. Other control information is carried by other means, in a more flexible manner.
Grant-free transmissions, which are supported in NR uplink transmissions, are also provided in NR sidelink transmissions, to improve the latency performance.
To achieve a high connection density, congestion control and thus the QoS management is supported in NR sidelink transmissions.

Some concepts about NR SL are described below.

### NR SL Physical Channels

In the NR sidelink, the following physical layer (PHY) channels are defined:
PSCCH (Physical Sidelink Common Control Channel): This channel carries sidelink control information (SCI) including part of the scheduling assignment (SA) that allows a receiver to further process and decode the corresponding PSSCH (e.g., demodulation reference signal (DMRS) pattern and antenna port, modulation and coding scheme (MCS), etc). In addition, the PSCCH indicates future reserved resources. This allows a RX to sense and predict the utilization of the channel in the future. This sensing information is used for the purpose of UE-autonomous resource allocation (Mode 2), which is described below.
PSSCH (Physical Sidelink Shared Channel): The PSSCH is transmitted by a sidelink transmitter UE, which conveys sidelink transmission data (i.e., the SL shared channel SL-SCH), and a part of the sidelink control information (SCI). In addition, higher layer control information may be carried using the PSSCH (e.g., MAC CEs, RRC signaling, etc.). For example, channel state information (CSI) is carried in the medium access control (MAC) control element (CE) over the PSSCH instead of the PSFCH.
PSFCH (Physical Sidelink feedback channel): The PSFCH is transmitted by a sidelink receiver UE for unicast and groupcast. It conveys the SL HARQ acknowledgement, which may consist of ACK/NACK (used for unicast and groupcast option 2) or NACK-only (used for groupcast option 1).
Physical Sidelink Broadcast Channel (PSBCH): The PSBCH conveys information related to synchronization, such as the direct frame number (DFN), indication of the slot and symbol level time resources for sidelink transmissions, in-coverage indicator, etc. The SSB is transmitted periodically at every 160 ms. The PSBCH is transmitted along with the S-PSS/S-SSS as a sidelink synchronization signal block (S-SSB).

Sidelink Primary/Secondary Synchronization Signal (S-PSS/S-SSS) are used by UEs to establish a common timing references among UEs in the absence of another reference such as GNSS time of NW time.

Along with the different physical channels, reference signals (RS) are transmitted for different purposes, including demodulation (DM-RS), phase tracking RS (PT-RS), or RS for channel state information acquisition (CSI-RS).

Another new feature is the two-stage sidelink control information (SCI). A first part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining part (second stage) of the SCI carries the remaining scheduling and control information such as a 8-bits source identity (ID) and a 16-bits destination ID, NDI, RV and HARQ process ID is sent on the PSSCH to be decoded by the receiver UE.

### Resource Allocation

NR sidelink supports the following two modes of resource allocation:
Mode 1: Sidelink resources are scheduled by a gNB.
Mode 2: The UE autonomously selects sidelink resources from a (pre-) configured sidelink resource pool. To avoid collisions between UEs a procedure based on the channel sensing and resource reservation is used.

An in-coverage UE can be configured by a gNB to use Mode 1 or Mode 2. For the out-of-coverage UE, only Mode 2 can be used.

Like in LTE, scheduling over the sidelink in NR is done in different ways for Mode 1 and Mode 2.

In Mode 1, the grant is provided by the gNB. Two kinds of grants are supported, namely, dynamic grants and configured grants.

Dynamic grants are provided for one or multiple transmissions of a single packet (i.e., transport block). When the traffic to be sent over sidelink arrives at a transmitter UE (i.e., at the corresponding TX buffer), the UE initiates the four-message exchange procedure to request sidelink resources from a gNB (SR on UL, grant, BSR on UL, grant for data on SL sent to UE). A gNB indicates the resource allocation for the PSCCH and the PSSCH in the downlink control information (DCI) conveyed by PDCCH with CRC scrambled with the SL-RNTI of the corresponding UE. A UE receiving such a DCI, assumes that it has been provided a SL dynamic grant only if the UE detects that the CRC of DCI has been scrambled with its SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.

Configured grants can be used to reduce latency. For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. This kind of grant is also known as grant-free transmissions.

Note that only the transmitter UE is scheduled by the gNB. The receiver UE does not receive any information directly from the gNB. Instead, it is scheduled by the transmitter UE by means of the SCI. Therefore, a receiver UE may need to perform blind decoding to identify the presence of PSCCH and find the resources for the PSSCH through the SCI.

In Mode 2 resource allocation, the grant is generated by the UE itself. When traffic arrives at a transmitter UE (i.e., at the corresponding TX buffer), this transmitter autonomously selects resources for the PSCCH and the PSSCH. To further enhance the probability of successful TB decoding at one shot and thus suppress the probability to perform retransmissions, a transmitter UE may repeat the TB transmission along with the initial TB transmission. These retransmissions may be triggered by the corresponding SL HARQ feedback or may be sent blindly by the transmitter UE. In either case, to minimize the probability of collision for potential retransmissions, the transmitter UE may also reserve the corresponding resources for PSCCH/PSSCH for retransmissions. That is, the transmitter UE selects resources for the PSCCH/PSSCH corresponding to the first transmission and the PSCCH/PSCCH corresponding to the retransmissions. Resources for up to 2 retransmissions may be reserved. These reserved resources are always used in case of blind retransmissions. If SL HARQ feedback is used, the use of the reserved resources is conditional on a negative SL HARQ acknowledgement.

Since each transmitter UE in sidelink transmissions may need to autonomously select resources for its own transmissions, preventing the different transmitter UEs from selecting the same resources turns out to be a critical issue in Mode 2. A particular resource selection procedure is therefore imposed to Mode 2 based on channel sensing. The channel sensing algorithm involves detecting the reservations transmitted by other UEs and performing power measurements (i.e., reference signal received power or RSRP) on the incoming transmissions.

### NR Sidelink Layer 2 (L2) UE-to-Network (U2N) Relay

In 3GPP TR 23.752 v 17.0.0 clause 6.7, the layer-2 based UE-to-Network relay is described. In particular, the protocol architecture supporting a L2 UE-to-Network Relay UE is provided. The L2 UE-to-Network Relay UE provides forwarding functionality that can relay any type of traffic over the PC5 link.

The L2 UE-to-Network Relay UE provides the functionality to support connectivity to the 5GS for Remote UEs. A UE is considered to be a Remote UE if it has successfully established a PC5 link to the L2 UE-to-Network Relay UE. A Remote UE can be located within NG-RAN coverage or outside of NG-RAN coverage.

FIG. 1 illustrates the protocol stack for the user plane transport, related to a PDU Session, including a Layer 2 UE-to-Network Relay UE. The PDU layer corresponds to the PDU carried between the Remote UE and the Data Network (DN) over the PDU session. It is important to note that the two endpoints of the PDCP link are the Remote UE and the gNB. The relay function is performed below PDCP. This means that data security is ensured between the Remote UE and the gNB without exposing raw data at the UE-to-Network Relay UE.

The adaptation relay layer within the UE-to-Network Relay UE can differentiate between signaling radio bearers (SRBs) and data radio bearers (DRBs) for a particular Remote UE. The adaption relay layer is also responsible for mapping PC5 traffic to one or more DRBs of the Uu. The definition of the adaptation relay layer is under the responsibility of RAN WG2.

FIG. 2 illustrates the protocol stack of the non-access stratum (NAS) connection for the Remote UE to the NAS-MM and NAS-SM components. The NAS messages are transparently transferred between the Remote UE and 5G-AN over the Layer 2 UE-to-Network Relay UE using:
PDCP end-to-end connection where the role of the UE-to-Network Relay UE is to relay the PDUs over the signaling radio bear without any modifications.
N2 connection between the 5G-AN and AMF over N2.
N11 connection between AMF and SMF over N11.

The role of the UE-to-Network Relay UE is to relay the PDUs from the signaling radio bearer without any modifications.

There currently exist certain challenges related to the use of SL relay. SL relay is being standardized by 3GPP in NR Rel-17, which enables a remote UE to be able to connect to a gNB via a relay UE. During the Rel-17 time phase, the remote UE may be in coverage (IC) or out of coverage (OOC). For the remote UE in IC that has both a direct connection and an indirect connection, the remote UE is only allowed to use single connectivity to transmit data. Due to this restriction, it would be reasonable and straightforward for the remote UE to only use the indirect connection to transmit data to the gNB. With this restriction, i.e., the remote UE only uses single connectivity for data transfer and reception, it is beneficial to simplify design efforts in NR Rel-17. However, the drawback is that the remote UE is not able to utilize the second connection even if it is available. In case of high data volume, it would be helpful if the remote UE in IC can utilize both a direct connection and an indirect connection to achieve an increased aggregate data rate over both connections.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Since multipath communication can bring an improvement on transmission reliability and network throughput, it may be an attractive option to allow a remote UE to connect to a network using a direct path and also using a relay path via a relay UE. For the relay path, a backhaul link between the remote UE and the relay UE may be a SL backhaul link, or an ideal backhaul link with high throughput and low latency. Different types of backhaul links may need different configurations and/or functionalities. Various exemplary embodiments of the present disclosure propose a solution for enabling relaying for a remote UE using an ideal backhaul link.

According to a first aspect of the present disclosure, there is provided a method performed by a first UE (e.g., a remote UE, etc.). The method comprises: establishing a direct communication path to a network node and establishing an indirect communication path to the network node through a second UE. The indirect communication path comprises an ideal backhaul link between the first UE and the second UE. In accordance with an exemplary embodiment, the method further comprises: communicating with the network node over the direct communication path and the indirect communication path. In an embodiment, when a radio bearer (RB) of the first UE is mapped to the indirect communication path which comprises a first hop between the first UE and the second UE and a second hop between the second UE and the network node, a packet data convergence protocol (PDCP) entity of the RB is directly mapped to a radio link control (RLC) entity of the second hop in the indirect communication path.

In accordance with an exemplary embodiment, the ideal backhaul link may have a throughput greater than a throughput threshold and/or a latency less than a latency threshold.

In accordance with an exemplary embodiment, when the RB is mapped to the indirect communication path, one or more protocol layers beneath a PDCP layer may be absent from the first hop in the indirect communication path.

In accordance with an exemplary embodiment, an adaptation layer may be configured between the PDCP layer and a protocol layer which is present beneath the PDCP layer, on the first hop in the indirect communication path between the first UE and the second UE and/or the second hop in the indirect communication path between the second UE and the network node.

In accordance with an exemplary embodiment, the indirect communication path via the second UE may be preconfigured to the first UE.

In accordance with an exemplary embodiment, the indirect communication path may be established in response to a trigger event or trigger condition.

In accordance with an exemplary embodiment, the second UE may be selected from multiple relay UE candidates by the first UE and/or the network node according to a selection criterion.

In accordance with an exemplary embodiment, the mapping of the RB of the first UE to the indirect communication path may be based at least in part on: a configuration of channel mapping between the first hop and the second hop; and/or a configuration of quality of service (QoS) split between the first hop and the second hop.

In accordance with an exemplary embodiment, an adaptation layer on either the first hop in the indirect communication path between the first UE and the second UE or the second hop in the indirect communication path between the second UE and the network node may include an ID/index of the first UE and/or an ID/index of the RB mapped to the indirect communication path.

In accordance with an exemplary embodiment, when the RB is mapped to the indirect communication path, the first UE may determine whether a PDCP protocol data unit/service data unit, PDU/SDU, has been successfully received by the network node based at least in part on: a PDCP status report provided by the network node; and/or an RLC status report indicating whether the PDCP PDU/SDU has been successfully transmitted from the second UE to the network node; and/or information provided by the network node via the direct communication path to the first UE about whether the PDCP PDU/SDU is received on the indirect communication path.

In accordance with an exemplary embodiment, when the first UE determines a radio link failure (RLF) on the indirect communication path, the method according to the first aspect of the present disclosure may further comprise: performing recovery by initiating a radio resource control (RRC) connection reestablishment procedure and/or by signaling the network node of the RLF via the direct communication path.

In accordance with an exemplary embodiment, the establishment of the direct communication path and/or the indirect communication path between the first UE and the network node may be based at least in part on one or more admission control procedures.

In accordance with an exemplary embodiment, the first UE and the second UE may be configured with a common paging configuration.

In accordance with an exemplary embodiment, when the RB is mapped to both the direct communication path and the indirect communication path, the method according to the first aspect of the present disclosure may further comprise: determining whether to use one or both of the direct communication path and the indirect communication path to transmit data for the RB, according to an amount of data volume of the RB.

In accordance with an exemplary embodiment, the direct communication path may comprise a Uu connection.

In accordance with an exemplary embodiment, the first UE and the second UE may be configured in a same dedicated bandwidth part (BWP) over Uu.

According to a second aspect of the present disclosure, there is provided an apparatus which may be implemented as a first UE. The apparatus may comprise one or more processors and one or more memories storing computer program codes. The one or more memories and the computer program codes may be configured to, with the one or more processors, cause the apparatus at least to perform any step of the method according to the first aspect of the present disclosure.

In accordance with an exemplary embodiment, the one or more memories and the computer program codes may be configured to, with the one or more processors, cause the first UE at least to: establish a direct communication path to a network node and establish an indirect communication path to the network node through a second UE. The indirect communication path comprises an ideal backhaul link between the first UE and the second UE.

In accordance with another exemplary embodiment, the one or more memories and the computer program codes may be configured to, with the one or more processors, cause the first UE further to: communicate with the network node over the direct communication path and the indirect communication path. In an embodiment, when an RB of the first UE is mapped to the indirect communication path which comprises a first hop between the first UE and the second UE and a second hop between the second UE and the network node, a PDCP entity of the RB is directly mapped to an RLC entity of the second hop in the indirect communication path.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided a method performed by a network node (e.g., a base station such as gNB, etc.). The method comprises: establishing a direct communication path to a first UE. In accordance with an exemplary embodiment, the method further comprises: configuring the first UE to establish an indirect communication path to the network node through a second UE. The indirect communication path comprises an ideal backhaul link between the first UE and the second UE. In accordance with an exemplary embodiment, the method further comprises: communicating with the first UE over the direct communication path and the indirect communication path. In an embodiment, when an RB of the first UE is mapped to the indirect communication path which comprises a first hop between the first UE and the second UE and a second hop between the second UE and the network node, a PDCP entity of the RB is directly mapped to an RLC entity of the second hop in the indirect communication path.

In accordance with an exemplary embodiment, the ideal backhaul link may have a throughput greater than a throughput threshold and/or a latency less than a latency threshold.

In accordance with an exemplary embodiment, when the RB is mapped to the indirect communication path, one or more protocol layers beneath a PDCP layer may be absent from the first hop in the indirect communication path.

In accordance with an exemplary embodiment, an adaptation layer may be configured between the PDCP layer and a protocol layer which is present beneath the PDCP layer, on the first hop in the indirect communication path between the first UE and the second UE and/or the second hop in the indirect communication path between the second UE and the network node.

In accordance with an exemplary embodiment, configuring the first UE to establish the indirect communication path may comprise pre-configuring the first UE to establish the indirect communication path via the second UE.

In accordance with an exemplary embodiment, the method according to the fourth aspect of the present disclosure may further comprise: pre-configuring the first UE to establish indirect communication paths via a plurality of relay UEs.

In accordance with an exemplary embodiment, the configuration of the first UE by the network node to establish the indirect communication path may be in response to a trigger event or trigger condition.

In accordance with an exemplary embodiment, the second UE may be selected from multiple relay UE candidates by the first UE and/or the network node according to a selection criterion.

In accordance with an exemplary embodiment, the method according to the fourth aspect of the present disclosure may further comprise: configuring channel mapping and/or QoS split between the first hop and the second hop in the indirect communication path.

In accordance with an exemplary embodiment, the method according to the fourth aspect of the present disclosure may further comprise: informing at least part of the configuration of the channel mapping and/or the QoS split between the first hop and the second hop to at least one of the first UE and the second UE.

In accordance with an exemplary embodiment, the mapping of the RB of the first UE to the indirect communication path may be based at least in part on: the configuration of the channel mapping between the first hop and the second hop; and/or the configuration of the QoS split between the first hop and the second hop.

In accordance with an exemplary embodiment, an adaptation layer on either the first hop in the indirect communication path between the first UE and the second UE or the second hop in the indirect communication path between the second UE and the network node may include an ID/index of the first UE and/or an ID/index of the RB mapped to the indirect communication path.

In accordance with an exemplary embodiment, when the RB is mapped to the indirect communication path, the network node may determine whether a PDCP protocol data unit/service data unit, PDU/SDU, has been successfully received by the first UE based at least in part on: a PDCP status report provided by the first UE; and/or an RLC status report indicating whether the PDCP PDU/SDU has been successfully transmitted from the network node to the second UE; and/or information provided by the first UE via the direct communication path to the network node about whether the PDCP PDU/SDU is received on the indirect communication path.

In accordance with an exemplary embodiment, the establishment of the direct communication path and/or the indirect communication path between the first UE and the network node may be based at least in part on one or more admission control procedures.

In accordance with an exemplary embodiment, the direct communication path may comprise a Uu connection.

According to a fifth aspect of the present disclosure, there is provided an apparatus which may be implemented as a network node. The apparatus may comprise one or more processors and one or more memories storing computer program codes. The one or more memories and the computer program codes may be configured to, with the one or more processors, cause the apparatus at least to perform any step of the method according to the fourth aspect of the present disclosure.

In accordance with an exemplary embodiment, the one or more memories and the computer program codes may be configured to, with the one or more processors, cause the network node at least to: establish a direct communication path to a first UE, and configure the first UE to establish an indirect communication path to the network node through a second UE. The indirect communication path comprises an ideal backhaul link between the first UE and the second UE.

In accordance with another exemplary embodiment, the one or more memories and the computer program codes may be configured to, with the one or more processors, cause the network node further to: communicate with the first UE over the direct communication path and the indirect communication path. In an embodiment, when an RB of the first UE is mapped to the indirect communication path which comprises a first hop between the first UE and the second UE and a second hop between the second UE and the network node, a PDCP entity of the RB is directly mapped to an RLC entity of the second hop in the indirect communication path.

According to a sixth aspect of the present disclosure, there is provided a computer-readable medium having computer program codes embodied thereon which, when executed on a computer, cause the computer to perform any step of the method according to the fourth aspect of the present disclosure.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates the protocol stack for the user plane transport, related to a PDU Session, including a Layer 2 UE-to-Network Relay UE;

FIG. 2 illustrates the protocol stack of the NAS connection for the Remote UE to the NAS-MM and NAS-SM components;

FIG. 3 illustrates a direct connection and an indirect connection with an ideal backhaul link between a remote UE and a network node;

FIG. 4 illustrates an example of a user plane stack according to some embodiments;

FIG. 5 illustrates an example of a control plane stack according to some embodiments;

FIG. 6 is a flow chart illustrating operations of a user equipment according to some embodiments of inventive concepts;

FIG. 7 is a flow chart illustrating operations of a network node according to some embodiments of inventive concepts;

FIG. 8 is a block diagram of a communication system in accordance with some embodiments;

FIG. 9 is a block diagram of a user equipment in accordance with some embodiments;

FIG. 10 is a block diagram of a network node in accordance with some embodiments;

FIG. 11 is a block diagram of a host computer communicating with a user equipment in accordance with some embodiments;

FIG. 12 is a block diagram of a virtualization environment in accordance with some embodiments; and

FIG. 13 is a block diagram of a host computer communicating via a base station with a user equipment over a partially wireless connection in accordance with some embodiments.

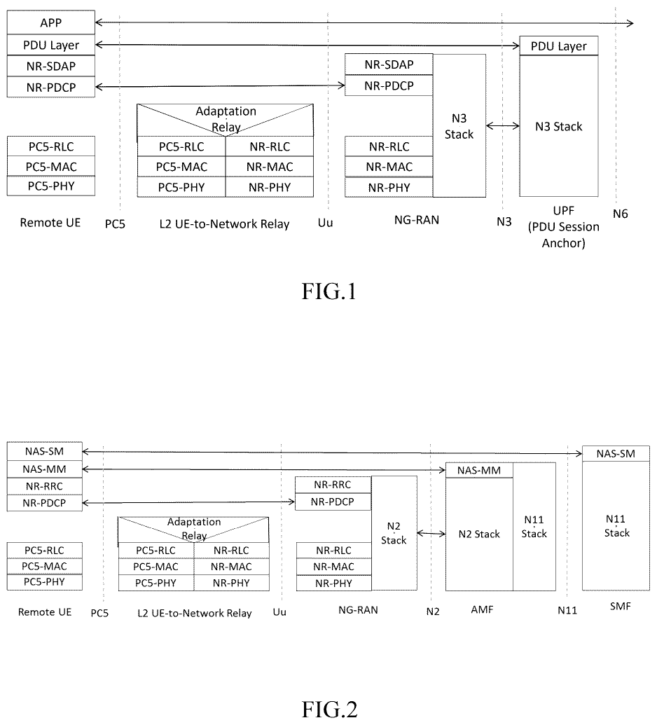

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

In the Rel-18 discussions on NR sidelink relay enhancements (i.e., 3GPP RP-221262), a study objective has been defined to study the benefit and potential solutions for multi-path support to enhance reliability and throughput (e.g., by switching among or utilizing the multiple paths simultaneously) in the scenario in which a UE is connected to the same gNB using one direct path and one indirect path via 1) Layer-2 UE-to-Network relay, or 2) via another UE (where the UE-UE inter-connection is assumed to be ideal), where the solutions for 1) are to be reused for 2) without precluding the possibility of excluding a part of the solutions which is unnecessary for the operation for 2).

As highlighted in the above objective, a UE is allowed to connect to the same gNB using two paths. There are two options which will be studied in 3GPP.
Option 1: the remote UE connects to the same gNB using a direct Uu path and a SL relay path which contains a SL backhaul and a Uu hop.
Option 2: the remote UE connects to the same gNB using a direct Uu path and a SL relay path which contains an ideal backhaul and a Uu hop.

The difference between the two options is in the backhaul link between the remote UE and a relay UE. Due to this difference, some of the functionalities of Option 1 would not be applicable for Option 2. Therefore, there is a need to determine what functionalities of Option 1 can be reused for Option 2, and to determine what additional changes/aspects may need to be studied for those functionalities. There is a further need to determine what functionalities of Option 1 cannot be reused, and therefore need to be disabled for the remote UE.

Certain aspects of the disclosure and their embodiments may provide solutions to these or other challenges. Some embodiments described herein provide mechanisms for enabling relaying for a remote UE using an ideal backhaul link to the relay UE. In some embodiments, the remote UE is able to select or reselect a suitable relay UE which has an ideal backhaul to the remote UE in order to set up an indirect path to the gNB. In some embodiments, the gNB is able to select or reselect a suitable relay UE which has an ideal backhaul to the remote UE according to various conditions.

Some embodiments define/identify which existing functions can be skipped for the remote UE to setup the indirect path in case the remote UE uses a relay UE which has an ideal backhaul to the remote UE.

Moreover, some embodiments define/identify which existing functions need to be improved for the remote UE to setup the indirect path in case the remote UE uses a relay UE which has an ideal backhaul to the remote UE.

Certain embodiments may provide one or more of the following technical advantage(s). Using the proposed mechanisms, a remote UE can find a relay UE which has an ideal backhaul link to the remote UE to setup a relay path, to improve transmission reliability or increase data volume.

In the following description, the term “node” is used which can be a network node or a UE. Examples of network nodes are NodeB, base station (BS), multi-standard radio (MSR) radio node such as MSR BS, eNodeB, gNodeB, MeNB, SeNB, integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, RRU, RRH, nodes in distributed antenna system (DAS), core network node (e.g. MSC, MME, etc.), O&M, OSS, SON, positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles, etc.

In some embodiments, generic terminology “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU), Remote Radio Head (RRH), Central Unit (e.g. in a gNB), Distributed Unit (e.g. in a gNB), Baseband Unit, Centralized Baseband, C-RAN, access point (AP, etc).

The term “radio access technology” or “RAT” may refer to any RAT, e.g. UTRA, E-UTRA, narrow band internet of things (NB-IoT), WiFi, Bluetooth, next generation RAT, New Radio (NR), 4G, 5G, etc. Any of the equipment denoted by the terminology “node”, “network node” or “radio network node” may be capable of supporting a single or multiple RATs.

Further, the present description uses the term “direct path” to stand for a direct connection from a remote UE to a gNB (e.g., via NR air interface) and uses the term “indirect path” to stand for an indirect connection between a remote UE and a gNB via an intermediate node also known as relay UE. In the description below, it is assumed that an indirect path contains two hops, i.e., first hop between a remote UE and a relay UE using an ideal backhaul link, and a Uu hop between a relay UE and a gNB.

Some embodiments described herein may be applicable to L2 relay scenarios. It can be appreciated that various embodiments described herein may also be applicable to other suitable relay scenarios.

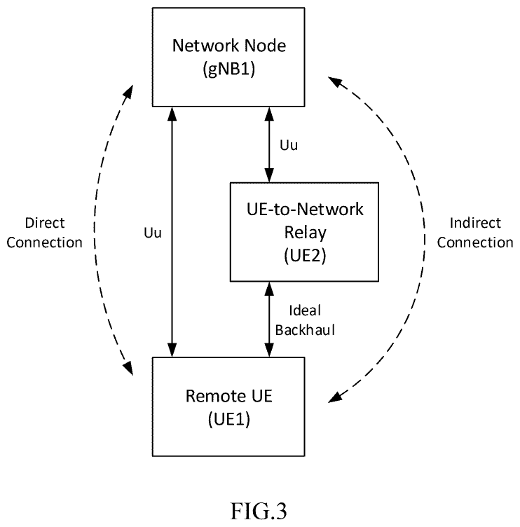

Referring to FIG. 3, in some embodiments, a UE (e.g., UE1) can connect to a network node (e.g., gNB1) via both a direct connection (i.e., UE1 connects to the gNB via the Uu link directly in cell 1) and an indirect connection (e.g., UE1 also connects to gNB1 via a relay UE, i.e., UE2 in cell 2). Cell 1 and cell 2 may be the same or different. The Uu connection between UE1/UE2 and gNB1 may be LTE Uu or NR Uu. The connection between UE1 and UE2 is an ideal backhaul link. That is, the connection between UE1 and UE2 may have a latency below a given latency threshold and/or a throughput above a given throughput threshold.

Some embodiments are also applicable to the case where UE1 connects to different gNBs via two different paths, wherein either of both paths can be a direct path or an indirect path containing an ideal backhaul link.

Some embodiments are also applicable to the case where a UE connects to different gNBs via more than two paths, wherein any one of the paths can be a direct path or an indirect path containing an ideal backhaul link.

An ideal backhaul link as used in the present description is a point-to-point connection with very high throughput and very low latency (e.g., the latency is no higher than a given threshold and/or a throughput above a given threshold). An ideal backhaul link can be a connection in any form including Ethernet, cable, fiber, wireless connection including WiFi, Uu, SL, Bluetooth, Zigbee, etc.

Some embodiments described herein are applicable to the scenario of Option 2, in which a remote UE connects to the same gNB using a direct Uu connection and an indirect connection that includes a relay path which contains an ideal backhaul link between the remote UE and a relay UE and a Uu hop between the relay UE and the gNB.

Since the backhaul link is ideal, some relay functionalities for L2 SL U2N relay may be able to be disabled or de-configured for the remote UE and/or the relay UE.

Some SL L2 U2N relay functionalities which are applicable to embodiments described herein may include (but are not limited to) at least one of the following:
Relay discovery;
Relay selection and reselection;
Configuration and deployment of the adaptation layer;
Channel mapping between end to end (E2E) radio bearers, RLC channels on the first hop, and RLC channels on the second hop;
End to end QoS management for E2E RBs;
System information forwarding;
Paging forwarding;
Admission control;
RLF detection and recovery procedure;
Connection establishment cause indications; and
Admission control and specific functionalities to support reduced capability (e.g., Redcap) NR UEs.

Referring to FIG. 3, in a first embodiment, in addition to a direct (Uu) path to gNB1, a UE (UE1) establishes an additional indirect path, concurrently with the direct path, via a relay UE (e.g., UE2) to gNB1, wherein the hop between UE1 and UE2 is an ideal backhaul link and the hop between UE2 and gNB1 is a Uu connection. That is, the connection between UE1 and UE2 may have a latency below a given latency threshold and/or a throughput above a given throughput threshold.

In accordance with an exemplary embodiment, UE1 may map an end-to-end (E2E) radio bearer (RB) to the paths using one of the following options:
Option 1: map the RB to the direct path
Option 2: map the RB to the indirect path. In this option, the PDCP entity of the RB can be directly mapped/associated to RLC entities on the second hop.
Option 3: map the RB to both the direct path and the indirect path.

In a second embodiment, for an RB which is mapped to an indirect path, protocol layers under the PDCP layer (e.g., Uu PDCP) including RLC (e.g., Uu RLC), MAC (e.g., Uu MAC) can be configured to be absent on the first hop. In this case, it is only the Physical layer which is configured under the PDCP layer. As another alternative, both the MAC layer and the PHY layer (fitting to the transmission medium) are present under the PDCP layer. As another alternative, the MAC layer and/or the PHY layer can be any lower layer (L2 and/or L1) fitting to the transmission medium.

As an additional embodiment, an adaptation layer may be configured between the PDCP layer and the Physical layer (or the MAC layer if it is present) on the first hop. In other words, whether to configure an adaptation layer between the PDCP layer and the Physical layer is optional (especially if 3GPP RAT such as SL is adopted on the first hop).

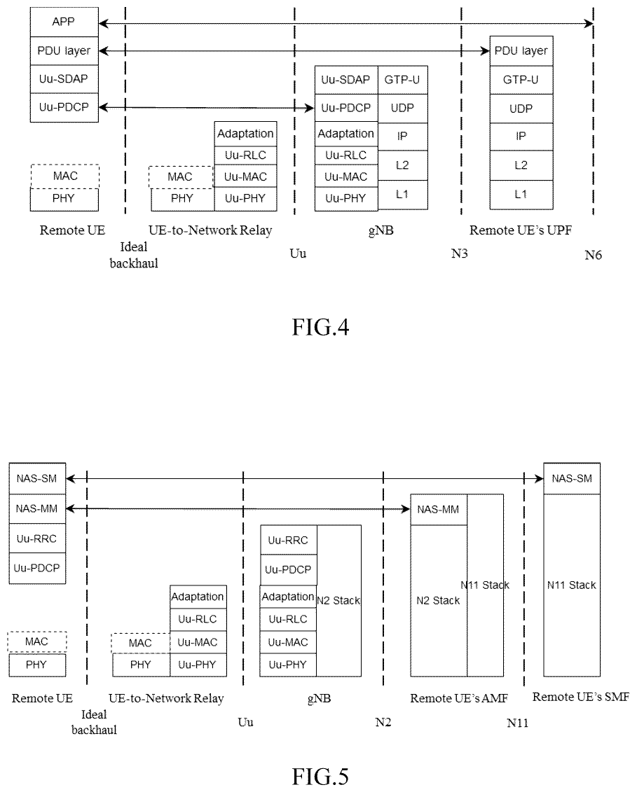

An example of the user plane and control plane protocol stack for the indirect path is illustrated in FIG. 4 and FIG. 5, respectively.

In one example, whether to configure an adaptation layer on the second hop may also be optional, e.g., when the relay UE only serves one remote UE, this is likely to the case as ideal backhaul is a point-to-point connection, in which case it is enough to skip the adaptation layer, which is mainly designed for routing and channel mapping purposes. If there is one remote UE mapped to one relay UE, the channel mapping function can be realized with configuration instead of the adaptation layer.

In a third embodiment, one or multiple potential relay UE candidates may be configured or preconfigured to UE1, wherein there is an ideal connection between each relay UE candidate and UE1. Whenever gNB1 has determined that an additional indirect path needs to be configured to UE1, gNB1 selects one of those relay UE candidates as a target relay UE and signals to UE1 via RRC signaling. Upon reception of the RRC signaling containing at least a target relay UE, UE1 sets up the indirect path towards gNB1 via the indicated target relay UE.

In an example, a relay UE candidate may be configured to UE1 by gNB1 via one or more of the following signaling alternatives:
System information;
Dedicated RRC signaling;
MAC CE; and
Layer 1 signaling (e.g., signaling carried on physical channels including PDSCH, PDCCH, etc.).

In an example, a relay UE candidate may be preconfigured to UE1.

In this way, the relay functions including relay discovery same as for L2 SL U2N relay can be skipped by UE1, and UE1 may not need to send a measurement report containing measurement results towards relay UE candidates to gNB1.

As an additional embodiment, UE1 may be triggered by certain conditions including one or more of the following:
Detection of RLF;
Arrival new data with critical QoS requirements; and
QoS requirements of a service are not satisfied if UE1 uses only the direct path.

Upon triggering of any of these conditions, UE1 will select one of the relay UE candidates by itself to setup the indirect path.

In case there are multiple relay UE candidates configured/preconfigured, UE1 or gNB1 may select a relay UE candidate according to one of the following options:
Option 1: randomly select a relay UE among all configured/preconfigured relay UE candidates.
Option 2: select the relay UE serving fewest number of remote UEs.
Option 3: select the relay UE with strongest Uu connection (e.g., highest Uu RSRP).
Option 4: select the relay UE which gives most free resources in the Uu connection.
Option 5: select the relay UE according to the capability of the relay UE. For example, one relay UE may have a capability which enables higher bitrate than the capability of another relay UE.
Option 6: select the relay UE according to the capabilities of the remote UE, e.g. if the remote UE is a reduced capability UE for example supporting reduced BW or reduced number of transmission chains compared to other NR UEs (for example, a reduced capability UE is a RedCap UE as specified in Rel-17 supporting max 20 MHz bandwidth for FR1, or further reduced capability UE to be specified in Rel-18). In one example, the relay UE requires specific functionality to support such reduced capability remote UEs.

In a fourth embodiment, for UE1, whenever gNB1 has determined to add an additional indirect path which contains an ideal backhaul between UE1 and the selected relay UE (e.g., UE2), gNB1 may perform the following actions to determine how to map a UE1's RB to the indirect path.
Action 1: configure the channel mapping between the first hop and the second hop.

In accordance with an exemplary embodiment, the channel mapping configuration may include at least one of the following information:
ID/Index of UE1.
Index/ID of the RB, where the RB needs to be mapped to the two hops (e.g., the first hop between UE1 and UE2 and the second hop between UE2 and gNB1).
Index/ID of the egress RLC channel on a first hop (e.g., the hop between UE1 and UE2). The mapping information for the first hop may be absent in the configuration, since there may be no lower layer protocol such as RLC in the first hop.
Index/ID of the egress RLC channel on the second hop between UE2 and gNB1.
Action 2: configure the QoS split between the first hop and the second hop.

In accordance with an exemplary embodiment, gNB1 may split the E2E QoS parameters between the two hops. In other words, the summarized per hop QoS parameters would be equal to the E2E QoS parameters.

The QoS parameters which are to be split may include at least one of e.g., PQI, PDB, PER, Bit rate, Maximum Data Burst Volume, etc.

In accordance with an exemplary embodiment, gNB1 may split/configure QoS parameters for each hop via one of the following options:
Option 1: gNB1 configures QoS parameters for the second hop (i.e., RLC channel) for the RB to be same as the E2E QoS parameter of the RB by assuming that RB has no QoS degradation on the first hop, e.g.,
   Packet latency in the first hop is Oms.
   No packet loss in the first hop.
   No packet transmission error in the first hop.
Option 2: gNB1 configures QoS parameters for the second hop (i.e., RLC channel) for the RB to be a fixed fraction (e.g., 95%) of the E2E QoS parameter of the RB by assuming that the RB has little or deterministic QoS degradation on the first hop, for example, by assuming that:
   Packet latency in the first hop is no higher than X ms.
   Packet latency in the first hop is a fixed quantity.
   Few packet loss in the first hop.
   Few packet transmission error in the first hop.
Option 3: For any one of the above options, gNB1 may skip splitting QoS parameters in the RRC signaling sent to UE1. Instead, how to split/configure QoS parameters for an RB between two hops are captured in specification in a hardcoded fashion.

As an additional embodiment, for the RB, gNB1 may not signal the channel mapping configuration to UE1.

As an additional embodiment, for the RB, gNB1 may not signal the QoS parameters configuration of the first hop to UE1.

As an additional embodiment, for the RB, gNB1 may signal the channel mapping configuration to UE2, which may only comprise the following information:
Index/ID of the RB, where the RB needs to be mapped to the two hops (e.g., the first hop between UE1 and UE2 and the second hop between UE2 and gNB).
Index/ID of the egress RLC channel on the second hop between UE2 and gNB1.

In this case, whenever UE2 has received a PDCP PDU (or an SDU/PDU of an adaptation layer if it is present between the PDCP layer and lower layers in the first hop) of the RB from UE1 on the first hop, UE2 can find the corresponding egress RLC channel on the second hop based on the channel mapping configuration. Vice versa, whenever UE2 has received a PDCP PDU/SDU of the adaption layer of the RB from gNB1 on the second hop, UE2 can find the corresponding PDCP entity based on the RB ID and UE1 ID contained in the adaptation layer header and deliver the PDCP PDU to the corresponding PDCP entity.

In a fifth embodiment, the adaptation layer on either the first hop or the second hop may comprise at least one of an ID/index of UEL and/or an ID/index of an RB.

The ID of a UE may be any Uu ID, such as C-RNTI, I-RNTI (full or short I-RNTI), resume ID, CS-RNTI, etc. The ID of a UE can be a short ID which is converted from any Uu ID. The short ID has shorter size than a normal Uu ID. In other words, gNB may need to maintain a mapping table between short IDs and Uu IDs.

UE1 may obtain a short ID for the adaptation layer via at least one of the following signaling options:
Option 1: UE1 obtains a short ID from gNB1 via signaling on the direct path.
Option 2: UE1 obtains a short ID from gNB1 via the relay UE (e.g., UE2) on the indirect path. gNB1 first signals the short ID to UE2, after receiving an assistance information signaling from UE2. UE2 forwards the short ID to UE1 via the ideal backhaul link.

The relay UE (e.g., UE2) may obtain a short ID for the adaptation layer for UE1 via at least one of the following signaling options:
Option 1: UE2 obtains the short ID for UE1 from gNB1.
Option 2: UE2 obtains the short ID of UEL from UE1 directly. In this option, UE1 first needs to obtain the short ID, after that, UE1 forwards the short ID to UE2.

In a sixth embodiment, for an RB mapped to the indirect path, UE1 determines whether a PDCP PDU/SDU has been successfully received by gNB1 based at least one of the following options.
Option 1: a PDCP status report provided by gNB1.

In order to enable the PDCP entity (e.g., receiving entity) in gNB1 to provide a status report to a PDCP transmitting entity, in addition to the following existing trigger conditions for PDCP status report (as captured in clause 5.4.1 of TS 38.323 v17.0.0):
Upper layer requests a PDCP entity re-establishment;
Upper layer requests a PDCP data recovery;
Upper layer requests an uplink data switching;
Upper layer reconfigures the PDCP entity to release DAPS and daps-SourceRelease is configured in upper layer (i.e., RRC),
at least one of the following new conditions may be configured to a PDCP receiving entity (e.g., UE1 in this case):
Upper layer (i.e., RRC) determines that a PDCP status report needs to be triggered, e.g., it is necessary for the PDCP receiving entity to provide a PDCP status report to the PDCP transmitting entity;
A periodic timer is expired;
PDCP duplication has been activated while at least one path is the indirect path;
The RB is a split RB, where the RB mapped to both the direct path and the indirect path;
UE1 has sent a signaling to gNB1 (via the direct path) for requesting a PDCP status report for one or multiple RBs.
Option 2: one of the associated Uu transmitting RLC entities on the second hop has received corresponding RLC status reports from gNB1 indicating that the PDCP PDU has been successfully transmitted in the Uu hop. If the RLC entity on the second hop of UE2 receives a status report indicating the successful reception of the RLC SDU/PDCP PDU, this information can be forwarded to UE1 via signaling over the ideal link to UE1.

In case an adaptation layer configured on the second hop, one or multiple PDCP PDUs/SDUs may be included in one PDU of the adaption layer. One adaption layer PDU may correspond to one or multiple RLC PDUs. In this case, gNB1 and/or UE2 may send an RLC status report for multiple PDCP PDUs/SDUs in an RLC status report message.
Option 3: gNB1 provides a signaling via the direct path to UE1 of acknowledging reception of the PDCP PDU on the indirect path.

For this option, gNB1's PDCP entity may provide a status report to UE1 via the direct path indicating successful reception of the PDCP PDU on the indirect path.

For this option, gNB1 may use other signaling options including RRC signaling, MAC CE, or L1 signaling (e.g., PDCCH) via the direct path indicating successful reception of the PDCP PDU on the indirect path.

In a seventh embodiment, for an RB mapped to the indirect path, gNB1 determines whether a PDCP PDU/SDU has been successfully received by UE1 based at least one of the following options:
Option 1: a PDCP status report provided by UE1. This option is similar as Option 1 in the sixth embodiment.
Option 2: one of the associated Uu transmitting RLC entities on the first hop has received corresponding RLC status reports from UE2 indicating that the PDCP PDU/SDU has been successfully transmitted in the Uu hop. This option is similar as Option 2 in the sixth embodiment.
Option 3: UE1 provides a signaling via the direct path to gNB1 of acknowledging reception of the PDCP PDU on the indirect path. This option is similar as Option 3 in the sixth embodiment.

In the seventh embodiment, UE1 may declare RLF for an indirect path when at least one of the following events occurs:
Relay UE declares/detects RLF in its Uu connection.
Relay UE has triggered handover.
Relay UE has triggered a random access procedure, due to one or more of the following reasons, e.g.,
   RRC Connection Re-establishment procedure;
   DL or UL data arrival during RRC_CONNECTED when UL synchronization status is “non-synchronized”;
   UL data arrival during RRC_CONNECTED when there are no PUCCH resources for SR available;
   SR failure;
   Request by RRC upon synchronous reconfiguration (e.g. handover);
   To establish time alignment for a secondary TAG;
   Request for Other SI;
   Beam failure recovery;
   Consistent UL LBT failure on SpCell;
   Positioning purpose during RRC_CONNECTED requiring a random access procedure, e.g., when timing advance is needed for UE positioning.

In case the remote UE has declared RLF for the indirect path, the remote UE may choose one of the following options to perform recovery.
Option 1: initiate the RRC connection reestablishment procedure.
Option 2: signal gNB of the RLF event for the indirect path via the direct path.

In an eighth embodiment, the remote UE may reselect a relay UE from the relay UE candidate list when the remote UE has declared/detected RLF on the indirect path. The remote UE may reselect a relay UE via one of the following options:
Option 1: randomly select a relay UE among all configured/preconfigured relay UE candidates.
Option 2: select the relay UE serving fewest number of remote UEs.
Option 3: select the relay UE with strongest Uu connection (e.g., highest Uu RSRP).
Option 4: select the relay UE which gives most free resources in the Uu connection.
Option 5: select the relay UE according to the capability of the relay UE. For example, one relay UE may have a capability which enables higher bitrate than the capability of another relay UE.
Option 6: select the relay UE according to the capabilities of the remote UE, e.g. if the remote UE is a reduced capability UE for example supporting reduced BW or reduced number of transmission chains compared to other NR UEs (for example, a reduced capability UE is a RedCap UE as specified in Rel-17 supporting max 20 MHz bandwidth for FR1, or further reduced capability UE to be specified in Rel-18). In one example, the relay UE requires specific functionality to support such reduced capability remote UEs.

In a ninth embodiment, one or multiple UE capability bits are defined for a remote UE indicating whether the remote UE supports an ideal backhaul link to a relay UE.

Meanwhile, one or multiple UE capability bits are defined for a relay UE indicating whether the relay UE supports to operate as a relay UE providing an ideal backhaul link to a remote UE.

In one example, the capability bits may also indicate other capabilities than the above, e.g., supported modulation schemes, number of antennas, max number of BWPs, subcarrier spacing, maximum supported bandwidth, number of transmission or reception chains, maximum supported MIMO layers, etc. In one example, the capability bits indicate whether the UE is a reduced capability UE (for example, a reduced capability UE is a RedCap UE as specified in Rel-17 supporting max 20 MHz bandwidth for FR1, or further reduced capability UE to be specified in Rel-18).

In a tenth embodiment, the remote UE in the fourth and ninth embodiments upon indicating the capability to support an ideal backhaul link to a relay UE, can request for configurations of the relay UE based on signaling over the direct path. That is, the remote UE can request the corresponding Layer-2 (RLC/MAC/PHY) configurations or Layer-1 (PHY) configurations for the indirect path depending on the option as in the previous embodiments. The remote UE can also obtain corresponding updates to the configurations, i.e., reconfigurations for the indirect path either initiated by the remote UE itself or by the gNB. The request for this configuration can be included in the uplink UE assistance information. In addition, the remote UE's request can include an ID that is:
Self-assigned by the relay UE for e.g., a sidelink L2 ID,
Assigned by the gNB based on the initial request in the UE assistance information, or
Assigned by the corresponding remote UE and included in the initial request as a part of the UE assistance information.

In an eleventh embodiment, a relay UE and a remote UE may perform one joint admission control procedure to determine whether the relay UE and the remote UE can access the network. The admission control procedure may for example be a check whether the relay UE and the remote UE need to be barred from the cell (i.e. not allowed to access the cell, for a certain period of time). If the joint admission control procedure determines that the UEs can access the cell, the relay and remote UEs will consider themselves allowed to access the cell, but if the joint admission control procedure results in that the UEs cannot access the cell, neither the relay UE nor the remote UE will consider themselves allowed to access the cell. This joint procedure may be performed in the relay UE and the outcome may be communicated to the remote UE, or vice versa.

In one example the admission control may take into account whether the remote UE is a RedCap UE, and in the case the gNB or cell does not indicate support for RedCap UEs in system information, neither the relay UE nor the remote UE will consider themselves allowed to access the cell.

Alternatively or additionally, the relay UE and the remote UE may perform independent admission control procedures, meaning that there is one admission control procedure performed for the relay UE and another admission control procedure performed for the remote UE. This may result in that either both UEs are allowed to access the cell, that neither of the UEs are allowed to access the cell, or that only one of the two UEs are allowed to access the cell. In case only the remote UE is allowed to access the cell, the remote UE would only communicate with the network and do so in a direct manner (i.e. not via the relay). Another approach is that the remote UE attempts to establish a connection to the network via another (candidate) relay UE. If only the relay UE is allowed to access the cell, while the remote UE is not, then the relay UE may refrain from accessing the cell anyway since the relay UE may in this case have nothing to communicate with the network (e.g. if the relay UE only is intending to connect to the network for the purpose of relaying traffic from the remote UE to the network).

In one example, the admission control may take into account whether the remote UE is a RedCap UE, and in the case the gNB or cell does not indicate support for RedCap UEs in system information, but the relay UE is not a RedCap UE, then the relay UE is allowed to access the cell and relay the traffic from the remote (RedCap) UE in indirect manner (i.e. only through the relay UE) but it is not allowed for the RedCap UE to operate in direct manner directly over Uu interface in the cell.

In another version of this embodiment, an admission control procedure is not performed for the relay UE (or the remote UE), and instead an admission control procedure is only performed for the remote UE (or the relay UE). If the remote UE (or the relay UE) is allowed to access the cell (as a result of the admission control procedure), the relay UE (or the remote UE) is also allowed to access the cell.

In a twelfth embodiment, a remote UE may always be connected to the relay UE via an ideal backhaul connection, regardless of whether the relay UE and/or remote UE have Uu coverage, whether the remote UE has an active PDU session/traffic to transmit, the RRC state of the relay UE/remote UE, etc. This may be the case when the relay UE connects to the remote UE via cable or when they are co-located. The relay UE may inform the remote UE of some assistance information either proactively or based on request from the remote UE, where the assistance information may contain/indicate one or more of:
whether it is ready for relaying SIB/paging,
whether it is ready for relaying data traffic,
its Uu quality (level), etc.

Meanwhile, a remote UE/relay UE may inform its serving gNB that it is connected to a relay UE/remote UE via an ideal connection. In this message, the remote UE and/or relay UE may be identified by any Uu ID, e.g., TMSI or IMSI, etc. The remote UE may also forward the assistance information obtained from the relay UE to the gNB. On the other hand, in the measurement report, the remote UE does not include the measurement results of relay UE(s) with the ideal connection (or simply only reports Uu link measurement) to the remote UE. Based on which, the gNB can determine whether the remote UE can use a relay UE with an ideal connection/backhaul to the remote UE, to setup the indirect connection to the gNB.

In a thirteenth embodiment, a remote UE and a relay UE that are connected via an ideal connection/backhaul can be configured with a common paging configuration, e.g., same POs, which could be e.g., the POs of the relay UE. By this the relay UE does not need to monitor additional POs in order to receive paging for the remote UE. The remote UE will also apply such paging configuration when monitor paging over the direct path. To do this the NW may need to know the linking relationship between the remote UE and the relay UE.

In a fourteenth embodiment, a remote UE in RRC IDLE/INACTIVE and connected to a relay UE via an ideal connection may not perform Uu measurement and cell (re) selection when the connected relay UE informs it that the relay UE is ready for relaying SIB/paging and/or data traffic, i.e., the remote UE always relies on the relay UE to be reached whenever possible. On the other hand, a relay UE in RRC IDLE/INACTIVE and connected to a remote UE via an ideal connection may only perform Uu measurement and cell (re) selection when the connected remote UE requests it to do so. When the UE performs paging area update, it may inform the gNB and/or the core NW of the information on the connected peer UE. Alternatively, whenever the UE has changed paging area, the UE may trigger its peer UE to perform its own paging area update. In yet another option, when the core NW and/or the gNB receives paging area update from the UE, it automatically performs update for the peer UE of the UE.

In a fifteenth embodiment, in the first hop between the remote UE and the relay UE, the relay UE may inform the remote UE of the amount of data in its TX RLC buffer and optionally the RB IDs that are mapped to the RLC channel (another way is that the gNB informs the mapping to the remote UE). When the RB is a split RB mapped to both the direct path and the indirect path, the remote UE determines to use which path(s) to transmit the data for the RB via the following options:
Option 1: the remote UE submits PDCP PDUs of the RB to the direct path and/or the indirect path when the amount of data volume is equal to larger than a threshold.
Option 2: otherwise, the remote UE submits PDCP PDUs of the RB to only one path (which is either the direct path or the indirect path according to configuration provided by the gNB or pre-configuration).

The amount of data volume of an RB can be determined by the remote UE considering at least one of the following:
PDCP data volume of the RB at the remote UE.
RLC data volume pending for initial transmission and/or retransmission associated with the RB at the relay UE.

In a sixteenth embodiment, the remote UE and the relay UE may be configured in the same dedicated UL and DL BWP over Uu. In another example, the relay UE is configured to use only the initial UL and DL BWP. The reason for configuring the relay UE only on the initial BWPs is that a relay UE may serve more than one remote UE and by mandating the same BWP for the relay UE will minimize the need for BWP switching and possible retuning of receivers and transmitters which will lead to extra latency. In another option, the relay UE uses the same dedicated BWP to serve all its connected remote UEs.

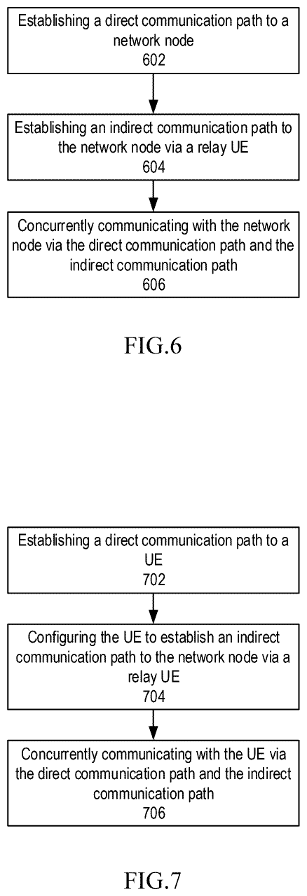

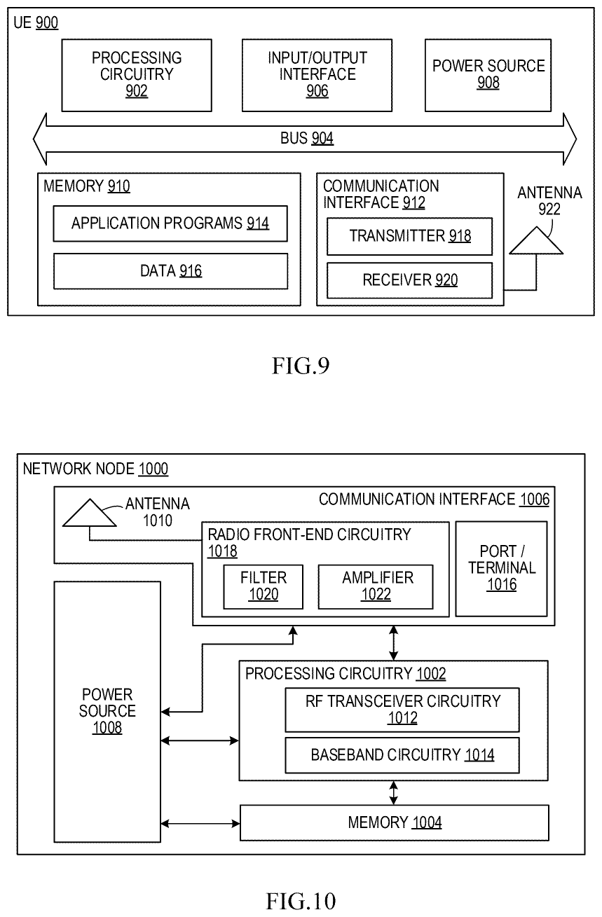

Operations of the communication device 900 (implemented using the structure of the block diagram of FIG. 9) will now be discussed with reference to the flow chart of FIG. 6 according to some embodiments of inventive concepts. For example, modules may be stored in memory 910 of FIG. 9, and these modules may provide instructions so that when the instructions of a module are executed by respective communication device processing circuitry 902, processing circuitry 902 performs respective operations of the flow chart.

Referring to FIG. 6, a method performed by a user equipment (UE) for communicating with a network node is illustrated. The method includes establishing (602) a direct communication path to a network node, establishing (604) an indirect communication path to the network node through a relay UE, wherein the indirect communication path comprises an ideal backhaul link between the user equipment and the relay UE, and concurrently communicating (606) with the network node over the direct communication path and the indirect communication path.

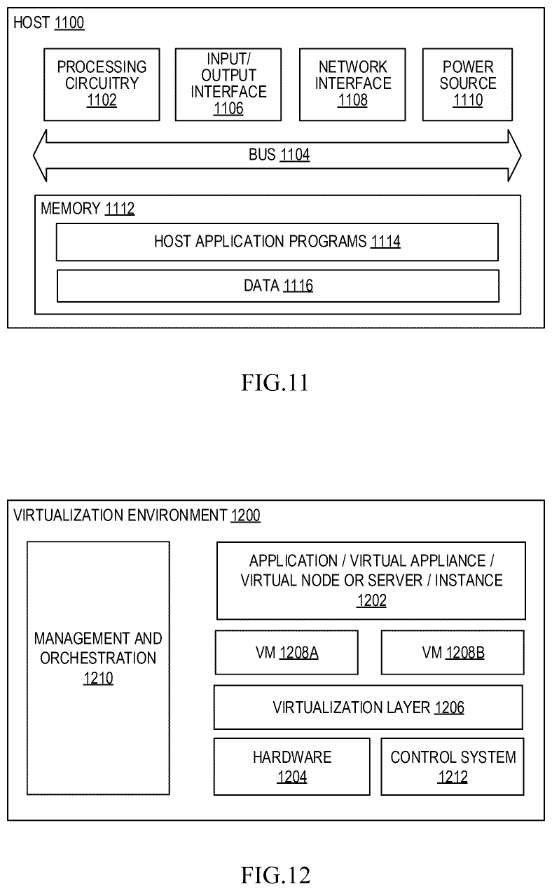

Operations of the RAN node 1000 (implemented using the structure of FIG. 10) will now be discussed with reference to the flow chart of FIG. 7 according to some embodiments of inventive concepts. For example, modules may be stored in memory 1004 of FIG. 10, and these modules may provide instructions so that when the instructions of a module are executed by respective RAN node processing circuitry 1002, RAN node 1000 performs respective operations of the flow chart.

Referring to FIG. 7, a method performed by a network node for communicating with a user equipment (UE) is illustrated. The method includes establishing (702) a direct communication path to the UE, configuring (704) the UE to establish an indirect communication path to the network node through a relay UE, wherein the indirect communication path comprises an ideal backhaul link between the user equipment and the relay UE, and concurrently communicating (706) with the UE over the direct communication path and the indirect communication path.

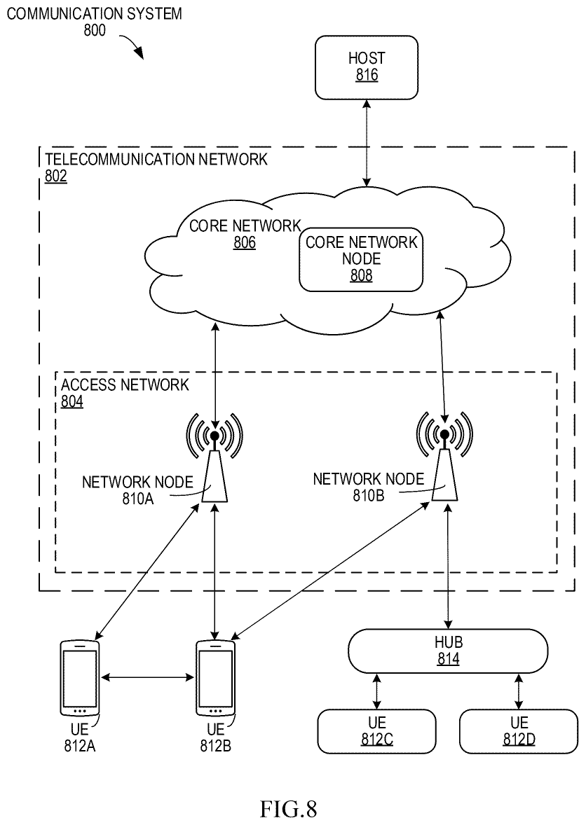

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810A and 810B (one or more of which may be generally referred to as network nodes 810), or any other similar 3rd Generation Partnership Project (3GPP) access node or non-3GPP access point. The network nodes 810 facilitate direct or indirect connection of user equipment (UE), such as by connecting UEs 812A, 812B, 812C, and 812D (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one or more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812C and/or 812D) and network nodes (e.g., network node 810B). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810B. The hub 814 may also allow for a different communication scheme and/or schedule between the hub 814 and UEs (e.g., UE 812C and/or 812D), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810B. In other embodiments, the hub 814 may be a non-dedicated hub—that is, a device which is capable of operating to route communications between the UEs and network node 810B, but which is additionally capable of operating as a communication start and/or end point for certain data channels.

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card’. The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and an RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208A and 1208B (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

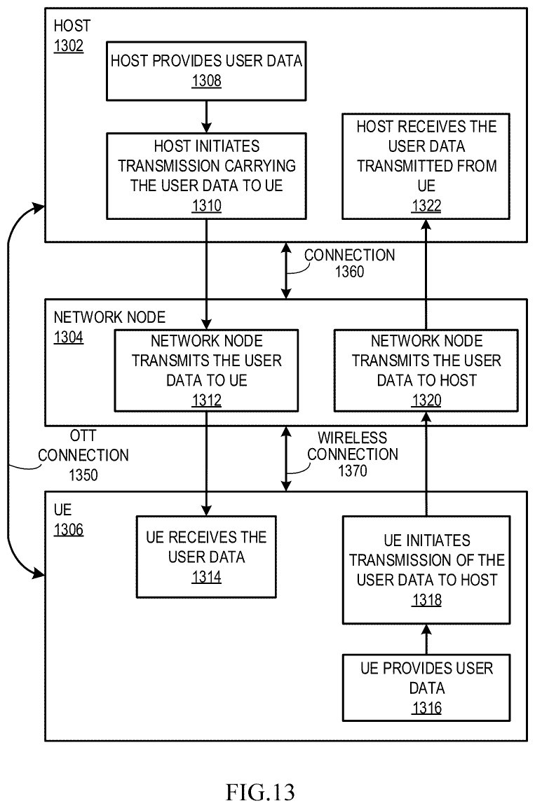

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812A of FIG. 8 and/or UE 900 of FIG. 9), network node (such as network node 810A of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve the data rate and/or latency of communications by/with remote UEs and thereby provide benefits such as reduced waiting time and better responsiveness.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Notably, modifications and other embodiments of the present disclosure will come to mind to one skilled in the art having the benefit of the teachings presented in the foregoing descriptions and the associated drawings. Therefore, it is to be understood that the inventive concept(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a user equipment (UE) for communicating with a network node, the method comprising:
establishing (602) a direct communication path to a network node;
establishing (604) an indirect communication path to the network node through a relay UE, wherein the indirect communication path comprises an ideal backhaul link between the user equipment and the relay UE; and concurrently communicating (606) with the network node over the direct communication path and the indirect communication path.

A2. The method of Embodiment A1, wherein the direct communication path comprises a Uu connection.

A3. The method of Embodiment A1 or A2, wherein the ideal backhaul link has a throughput greater than a throughput threshold and/or a latency less than a latency threshold.

A4. The method of any previous Embodiment, wherein the network node comprises a gNB.

A5. The method of any previous Embodiment, further comprising:
mapping a radio bearer to the indirect communication path, to the direct communication path or to both the direct communication path and the indirect communication path.

A6. The method of Embodiment A5, wherein the radio bearer is mapped to the indirect path, wherein a PDCP entity of the radio bearer is directly mapped to an RLC entity of a hop in the indirect communication path between the relay UE and the network node.

A7. The method of Embodiment A5, wherein the radio bearer is mapped to the indirect path, wherein protocol layers beneath the PDCP layer are absent from a first hop in the indirect communication path between the UE and the relay UE.

A8. The method of any previous Embodiment, wherein the indirect path via the relay UE is preconfigured to the UE.

A9. The method of any previous Embodiment, wherein the indirect communication path is established in response to a trigger event or trigger condition.

A10. The method of any previous Embodiment, wherein an adaptation layer on either a first hop in the indirect communication path between the UE and the relay UE or a second hop in the indirect communication path between the relay UE and the network node includes an ID/index of the UE and/or an ID/index of a radio bearer mapped to the indirect communication path.

A11. The method of any of the previous embodiments, further comprising:
providing user data; and
forwarding the user data to a host via the transmission to the network node.

### Group B Embodiments

B1. A method performed by a network node for communicating with a user equipment (UE), comprising:
establishing (702) a direct communication path to the UE;
configuring (704) the UE to establish an indirect communication path to the network node through a relay UE, wherein the indirect communication path comprises an ideal backhaul link between the user equipment and the relay UE; and
concurrently communicating (706) with the UE over the direct communication path and the indirect communication path.

B2. The method of Embodiment B1, wherein configuring the UE to establish the indirect communication path comprises pre-configuring the UE to establish the indirect communication path via the relay UE.

B3. The method of Embodiment B2, further comprising:
pre-configuring the UE to establish indirect communication paths via a plurality of relay UEs.

B4. The method of any previous Embodiment, further comprising:
configuring the UE to establish the indirect communication path in response to a trigger event or trigger condition.

B5. The method of any previous Embodiment, wherein the direct communication path comprises a Uu connection.

B6. The method of any previous Embodiment, wherein the ideal backhaul link has a throughput greater than a throughput threshold and/or a latency less than a latency threshold.

B7. The method of any previous Embodiment, wherein the network node comprises a gNB.

B8. The method of any of the previous embodiments, further comprising:
obtaining user data; and
forwarding the user data to a host or a user equipment.

### Group C Embodiments

C1. A user equipment for communicating with a network node, comprising:
processing circuitry configured to perform any of the steps of any of the Group A embodiments; and
power supply circuitry configured to supply power to the processing circuitry.

C2. A network node for communicating with a user equipment, the network node comprising:
processing circuitry configured to perform any of the steps of any of the Group B embodiments;
power supply circuitry configured to supply power to the processing circuitry.

C3. A user equipment (UE) for communicating with a network node, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C4. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

C5. The host of the previous embodiment, wherein the cellular network further includes a network node configured to communicate with the UE to transmit the user data to the UE from the host.

C6. The host of the previous 2 embodiments, wherein:
the processing circuitry of the host is configured to execute a host application, thereby providing the user data; and
the host application is configured to interact with a client application executing on the UE, the client application being associated with the host application.

C7. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

C8. The method of the previous embodiment, further comprising:
at the host, executing a host application associated with a client application executing on the UE to receive the user data from the UE.

C9. The method of the previous embodiment, further comprising:
at the host, transmitting input data to the client application executing on the UE, the input data being provided by executing the host application,
wherein the user data is provided by the client application in response to the input data from the host application.

C10. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

C11. The host of the previous embodiment, wherein the cellular network further includes a network node configured to communicate with the UE to transmit the user data from the UE to the host.

C12. The host of the previous 2 embodiments, wherein:
the processing circuitry of the host is configured to execute a host application, thereby providing the user data; and
the host application is configured to interact with a client application executing on the UE, the client application being associated with the host application.

C13. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

C14. The method of the previous embodiment, further comprising:
at the host, executing a host application associated with a client application executing on the UE to receive the user data from the UE.

C15. The method of the previous embodiment, further comprising:
at the host, transmitting input data to the client application executing on the UE, the input data being provided by executing the host application,
wherein the user data is provided by the client application in response to the input data from the host application.

C16. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

C17. The host of the previous embodiment, wherein:
the processing circuitry of the host is configured to execute a host application that provides the user data; and
the UE comprises processing circuitry configured to execute a client application associated with the host application to receive the transmission of user data from the host.

C18. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

C19. The method of the previous embodiment, further comprising, at the network node, transmitting the user data provided by the host for the UE.

C20. The method of any of the previous 2 embodiments, wherein the user data is provided at the host by executing a host application that interacts with a client application executing on the UE, the client application being associated with the host application.

C21. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

C22. The communication system of the previous embodiment, further comprising:
the network node; and/or
the user equipment.

C23. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

C24. The host of the previous 2 embodiments, wherein:
the processing circuitry of the host is configured to execute a host application, thereby providing the user data; and
the host application is configured to interact with a client application executing on the UE, the client application being associated with the host application.

C25. The host of the any of the previous 2 embodiments, wherein the initiating receipt of the user data comprises requesting the user data.

C26. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

C27. The method of the previous embodiment, further comprising at the network node, transmitting the received user data to the host.

Explanations are provided below for various abbreviations/acronyms used in the present disclosure.

| Abbreviation | Explanation |
|---|---|
| BS | Base Station |
| CAM | Cooperative Awareness Message |
| CE | Control Element |
| CN | Core Network |
| CSI-RS | Channel State Information Reference Signal |
| DL | Downlink |
| DM-RS | Demodulation Reference Signal |
| DRX | Discontinuous Reception |
| eNB | e-Node B |
| gNB | g-Node B |
| HARQ | Hybrid Automatic Repeat Request |
| ID | Identity |
| ITS | Intelligent Transport Systems |
| L2 | Layer 2 |
| LBT | Listen Before Talk |
| LCH | Logical Channel |
| LCG | Logical Channel Group |
| LTE | Long Term Evolution |
| MAC | Medium Access Control |
| NR | New Radio |
| NW | Network |
| PDCP | Packet Data Convergence Protocol |
| PDU | Protocol Data Unit |
| PER | Packet Error Rate |
| PHY | Physical (layer) |
| PQI | Packet Quality Indicator |
| PSBCH | Physical Sidelink Broadcast Channel |
| PSCCH | Physical Sidelink Control Channel |
| PSSCH | Physical Sidelink Shared Channel |
| PT-RS | Phase Tracking Reference Signal |
| QoS | Quality of Service |
| RB | Radio Bearer |
| RedCap | Reduced Capacity |
| RLC | Radio Link Control |
| RLF | Radio Link Failure |
| RNTI | Radio Network Temporary Identity |
| RRC | Radio Resource Control |
| RS | Reference Signal |
| RSRP | Reference Signal Received Power |
| RX | Reception, receiver |
| SA | Scheduling Assignment |
| SL | Sidelink |
| S-PSS | Sidelink Primary Synchronization Signal |
| S-SSB | Sidelink Synchronization Singal Block |
| S-SSS | Sidelink Secondary Synchronization Signal |
| TAG | Timing Alignment Group |
| TB | Transport Block |
| TX | Transmission, transmitter |
| UE | User Equipment |
| UL | Uplink |
| U2N | UE to Network |
| V2V | Vehicle-to-Vehicle |
| V2X | Vehicle-to-Anything. |

1. A method performed by a first user equipment, UE, comprising:
establishing a direct communication path to a network node;
establishing an indirect communication path to the network node through a second UE, wherein the indirect communication path comprises an ideal backhaul link between the first UE and the second UE, and the ideal backhaul link has a throughput greater than a throughput threshold and/or a latency less than a latency threshold;
communicating with the network node over the direct communication path and the indirect communication path; and
wherein when a radio bearer, RB, of the first UE is mapped to the indirect communication path which comprises a first hop between the first UE and the second UE and a second hop between the second UE and the network node, a packet data convergence protocol, PDCP, entity of the RB is directly mapped to a radio link control, RLC, entity of the second hop in the indirect communication path.

2. (canceled)

3. The method according to claim 1, wherein when the RB is mapped to the indirect communication path, one or more protocol layers beneath a PDCP layer are absent from the first hop in the indirect communication path.

4. The method according to claim 1, wherein an adaptation layer is configured between the PDCP layer and a protocol layer which is present beneath the PDCP layer, on the first hop in the indirect communication path between the first UE and the second UE and/or the second hop in the indirect communication path between the second UE and the network node.

5. The method according to claim 1, wherein the indirect communication path via the second UE is preconfigured to the first UE.

6. The method according to claim 1, wherein the indirect communication path is established in response to a trigger event or trigger condition.

7. The method according to claim 1, wherein the second UE is selected from multiple relay UE candidates by the first UE and/or the network node according to a selection criterion.

8. The method according to claim 1, wherein the mapping of the RB of the first UE to the indirect communication path is based at least in part on:
a configuration of channel mapping between the first hop and the second hop; and/or
a configuration of quality of service, QoS, split between the first hop and the second hop.

9. The method according to claim 1, wherein an adaptation layer on either the first hop in the indirect communication path between the first UE and the second UE or the second hop in the indirect communication path between the second UE and the network node includes an ID/index of the first UE and/or an ID/index of the RB mapped to the indirect communication path.

10. The method according to claim 1, wherein when the RB is mapped to the indirect communication path, the first UE determines whether a PDCP protocol data unit/service data unit, PDU/SDU, has been successfully received by the network node based at least in part on:
a PDCP status report provided by the network node;
an RLC status report indicating whether the PDCP PDU/SDU has been successfully transmitted from the second UE to the network node; and/or
information provided by the network node via the direct communication path to the first UE about whether the PDCP PDU/SDU is received on the indirect communication path.

11. The method according to claim 1, wherein when the first UE determines a radio link failure, RLF, on the indirect communication path, the method further comprise:
performing recovery by initiating a radio resource control, RRC, connection reestablishment procedure and/or by signaling the network node of the RLF via the direct communication path.

12. The method according to claim 1, wherein the establishment of the direct communication path and/or the indirect communication path between the first UE and the network node is based at least in part on one or more admission control procedures.

13. The method according to claim 1, wherein the first UE and the second UE are configured with a common paging configuration.

14. The method according to claim 1, wherein when the RB is mapped to both the direct communication path and the indirect communication path, the method further comprises:
determining whether to use one or both of the direct communication path and the indirect communication path to transmit data for the RB, according to an amount of data volume of the RB.

15. The method according to claim 1, wherein the direct communication path comprises a Uu connection.

16. The method according to claim 1, wherein the first UE and the second UE are configured in a same dedicated bandwidth part, BWP, over Uu.

17. A first user equipment, UE, comprising:
one or more processors; and
one or more memories comprising computer program codes,
the one or more memories and the computer program codes configured to, with the one or more processors, cause the first UE at least to:
establish a direct communication path to a network node;
establish an indirect communication path to the network node through a second UE, wherein the indirect communication path comprises an ideal backhaul link between the first UE and the second UE, and the ideal backhaul link has a throughput greater than a throughput threshold and/or a latency less than a latency threshold;
communicate with the network node over the direct communication path and the indirect communication path; and
wherein when a radio bearer, RB, of the first UE is mapped to the indirect communication path which comprises a first hop between the first UE and the second UE and a second hop between the second UE and the network node, a packet data convergence protocol, PDCP, entity of the RB is directly mapped to a radio link control, RLC, entity of the second hop in the indirect communication path.

18.-19. (canceled)

20. A method performed by a network node, comprising:
establishing a direct communication path to a first user equipment, UE;
configuring the first UE to establish an indirect communication path to the network node through a second UE, wherein the indirect communication path comprises an ideal backhaul link between the first UE and the second UE, and the ideal backhaul link has a throughput greater than a throughput threshold and/or a latency less than a latency threshold;
communicating with the first UE over the direct communication path and the indirect communication path, and
wherein when a radio bearer, RB, of the first UE is mapped to the indirect communication path which comprises a first hop between the first UE and the second UE and a second hop between the second UE and the network node, a packet data convergence protocol, PDCP, entity of the RB is directly mapped to a radio link control, RLC, entity of the second hop in the indirect communication path.

21. (canceled)

22. The method according to claim 20, wherein when the RB is mapped to the indirect communication path, one or more protocol layers beneath a PDCP layer are absent from the first hop in the indirect communication path.

23. The method according to claim 20, wherein an adaptation layer is configured between the PDCP layer and a protocol layer which is present beneath the PDCP layer, on the first hop in the indirect communication path between the first UE and the second UE and/or the second hop in the indirect communication path between the second UE and the network node.

24. The method according to claim 20, wherein configuring the first UE to establish the indirect communication path comprises pre-configuring the first UE to establish the indirect communication path via the second UE.

25. The method according to claim 20, further comprising:
pre-configuring the first UE to establish indirect communication paths via a plurality of relay UEs.

26. The method according to claim 20, wherein the configuration of the first UE by the network node to establish the indirect communication path is in response to a trigger event or trigger condition.

27. The method according to claim 20, wherein the second UE is selected from multiple relay UE candidates by the first UE and/or the network node according to a selection criterion.

28. The method according to claim 20, further comprising:
configuring channel mapping and/or quality of service, QoS, split between the first hop and the second hop in the indirect communication path; and
informing at least part of the configuration of the channel mapping and/or the QoS split between the first hop and the second hop to at least one of the first UE and the second UE.

29. The method according to claim 28, wherein the mapping of the RB of the first UE to the indirect communication path is based at least in part on:
the configuration of the channel mapping between the first hop and the second hop; and/or
the configuration of the QoS split between the first hop and the second hop.

30.-33. (canceled)

34. A network node, comprising:
one or more processors; and
one or more memories comprising computer program codes,
the one or more memories and the computer program codes configured to, with the one or more processors, cause the network node at least to:
establish a direct communication path to a first user equipment, UE;
configure the first UE to establish an indirect communication path to the network node through a second UE, wherein the indirect communication path comprises an ideal backhaul link between the first UE and the second UE, and the ideal backhaul link has a throughput greater than a throughput threshold and/or a latency less than a latency threshold;
communicate with the first UE over the direct communication path and the indirect communication path, and
wherein when a radio bearer, RB, of the first UE is mapped to the indirect communication path which comprises a first hop between the first UE and the second UE and a second hop between the second UE and the network node, a packet data convergence protocol, PDCP, entity of the RB is directly mapped to a radio link control, RLC, entity of the second hop in the indirect communication path.

35.-36. (canceled)
